(19) United States
(12) Patent Application Publication
(10) Pub. No.: US 2025/0005302 A1
(43) Pub. Date: Jan. 2, 2025

(54) INFORMATION PROCESSING APPARATUS, INFORMATION PROCESSING METHOD, AND RECORDING MEDIUM

(71) Applicant: NEC Corporation, Tokyo (JP)

(72) Inventors: Yudai YANO, Tokyo (JP); Hidenobu YAMAMOTO, Tokyo (JP); Hisatoshi KOBAYASHI, Tokyo (JP); Asuki NAKAMURA, Tokyo (JP); Kazuhisa IDE, Tokyo (JP); Yosuke USUI, Tokyo (JP); Satoshi YOSHIDA, Tokyo (JP)

(73) Assignee: NEC Corporation, Tokyo (JP)

(21) Appl. No.: 18/752,083

(22) Filed: Jun. 24, 2024

(30) Foreign Application Priority Data
Jun. 29, 2023 (JP) 2023-107457

(51) Int. Cl. G06F 40/40; G06F 40/20; G06N 20/00

(52) U.S. Cl. CPC G06F 40/40; G06F 40/20; G06N 20/00

(57) ABSTRACT

An information processing apparatus is provided which is capable of making an accurate correction to target data or suggesting making the correction. The information processing apparatus includes: an acquiring means for acquiring target data; a generating means for generating a target vector from the target data; and a correcting means for making a comparison between the target vector and a reference vector generated from reference data, and performing correction-related processing of the target data according to the result of the comparison.

### CROSS REFERENCE TO RELATED APPLICATIONS

This application is based upon and claims the benefit of priority from Japanese Patent Application No. 2023-107457 filed on Jun. 29, 2023, the disclosure of which is incorporated herein in its entirety by reference.

### TECHNICAL FIELD

The present disclosure relates to an information processing apparatus, an information processing method, and a recording medium.

### BACKGROUND ART

There are known techniques for assisting generation and correction of text data. For example, Patent Literature 1 discloses a technique for correcting target information such that the content of the target information is as intended by a user.

### CITATION LIST

### Patent Literature

### [Patent Literature 1]

International patent publication No. WO2021/220702

### SUMMARY OF INVENTION

### Technical Problem

With the technique disclosed in Patent Literature 1, a comparison between text regarding a user's remark and past information on the content of the remark is made, and candidate text of the remark is generated on the basis of the comparison. However, there is a problem with this technique, the problem being the difficulty in improving the accuracy of candidate text of a remark (in other words, the accuracy as to making a correction to text or suggesting making the correction to the text).

The present disclosure has been made in view of the above problem, and an example object thereof is to provide a technique by which it is possible to make an accurate correction to target data or suggest making the correction.

### Solution to Problem

An information processing apparatus in accordance with an example aspect of the present disclosure includes at least one processor, the at least one processor carrying out: an acquiring process of acquiring target data; a generating process of generating a target vector from the target data; and a correcting process of making a comparison between the target vector and a reference vector generated from reference data, and performing correction-related processing of the target data according to a result of the comparison.

An information processing method in accordance with an example aspect of the present disclosure includes: acquiring target data; generating a target vector from the target data; and making a comparison between the target vector and a reference vector generated from reference data, and performing correction-related processing of the target data according to a result of the comparison.

A recording medium in accordance with an example aspect of the present disclosure is a non-transitory recording medium having recorded thereon a program for causing a computer to carry out: an acquiring process of acquiring target data; a generating process of generating a target vector from the target data; and a correcting process of making a comparison between the target vector and a reference vector generated from reference data, and performing correction-related processing of the target data according to a result of the comparison.

### Advantageous Effects of Invention

An example aspect of the present disclosure produces an example advantage of being capable of making an accurate correction to target data or suggesting making the correction.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing apparatus in accordance with the present disclosure.

FIG. 4 is a flowchart illustrating a flow of an information processing method in accordance with the present disclosure.

FIG. 5 is a flowchart illustrating a flow of an information processing method in accordance with the present disclosure.

FIG. 6 is a flowchart illustrating a flow of an information processing method in accordance with the present disclosure.

FIG. 7 is a representation illustrating an example of a data comparison in accordance with the present disclosure.

FIG. 8 is a representation illustrating an example of a data comparison in accordance with the present disclosure.

FIG. 9 is a block diagram m illustrating a configuration of a computer which functions as the information processing apparatuses in accordance with the present disclosure.

### EXAMPLE EMBODIMENTS

Example embodiments of the present invention will be described below by way of example. It should be noted that the present invention is not limited to the example embodiments described below, but may be altered in various ways by a skilled person within the scope of the claims. For example, any example embodiment derived by appropriately combining technical means adopted in differing example embodiments described below can be within the scope of the present invention. Further, any example embodiment derived by appropriately omitting some of the technical means adopted in differing example embodiments described below can be within the scope of the present invention. Further, the advantage mentioned in each of the example embodiments is an example advantage expected in that example embodiment, and does not define the extension of the present invention. That is, an example embodiment which does not produce the example advantages mentioned in the example embodiments described below can also be within the scope of the present invention.

### First Example Embodiment

The following description will discuss a first example embodiment, which is an example embodiment of the present invention, in detail with reference to the drawings. The present example embodiment is basic to the example embodiment which will be described later. Note that the applicability of each of the technical means adopted in the present example embodiment is not limited to the present example embodiment. That is, each technical means adopted in the present example embodiment can be adopted in another example embodiment included in the present disclosure to the extent that no exceptional technical impediment is caused. Further, each of the technical means illustrated in the drawings referred to for describing the present example embodiment can also be adopted in another example embodiment included in the present disclosure to the extent that no exceptional technical impediment is caused.

### (Configuration of Information Processing Apparatus 1)

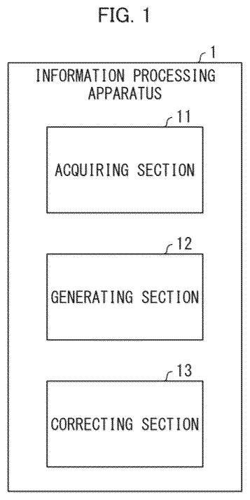

Here is a description of a configuration of an information processing apparatus 1, provided with reference to FIG. 1. FIG. 1 is a block diagram illustrating a configuration of the information processing apparatus 1. The information processing apparatus 1 includes an acquiring section 11, a generating section 12, and a correcting section 13, as illustrated in FIG. 1.

The information processing apparatus 1 is an apparatus for making a comparison between a target vector generated from target data and a reference vector generated from reference data, and performing data correction-related processing of the target according to the result of the comparison. Specific examples of the target data include an article and an editorial which are created in the mass media, although the present example embodiment is not limited to the specific examples. Further, specific examples of the reference data include data which is reflective of the tones of past article and editorial, or a social trend or the like, although the present example embodiment is not limited to the specific examples.

### (Acquiring Section 11)

The acquiring section 11 acquires target data DT. The target data DT may be, for example, at least one selected from the group consisting of an image, a voice, and text. The target data DT may be data of any field, and examples thereof include data such as an image, a voice, and text which are contained in an article and an editorial created in the mass media. Examples of the mass media include a newspaper and a broadcast.

### (Generating Section 12)

The generating section 12 generates a target vector from the target data DT. For example, the target vector represents the target data DT or one or more elements extracted from the target data DT, in the form of a vector in a feature space. The one or more elements extracted from the target data DT may be, for example, a predetermined keyword, predetermined wording, or a token.

### (Example of Target Vector Generation Method)

Here is a description of an example of a target vector generation method. However, the present example embodiment is not limited to this example. For example, in a case where the target data DT is text data such as a sentence, first of all, each word and each token which can be present in the target data DT are associated with predetermined numerical values in a one-to-one correspondence, in advance. Next, each word and each token which are present in the target data DT actually acquired are replaced with the predetermined numerical values which are associated therewith in advance, and the target data DT is converted into a string of numerical values, accordingly. The string of numerical values is then represented as a vector in a feature space by a predetermined rule or algorithm. A vector thus generated is the target vector.

### (Correcting Section 13)

The correcting section 13 makes a comparison between the target vector and a reference vector generated from reference data DR, and performs correction-related processing of the target data DT according to the result of the comparison.

The reference data DR may be, for example, at least one selected from the group consisting of an image, a voice, and text. The reference data DR may be data in any field, and is, for example, data which indicates the tones of past article and editorial created in the mass media, or a social trend or the like. The data indicating a social trend can be acquired as, for example, respective pieces of data (also referred to as pieces of trend data) created by a plurality of persons, the pieces of data being at least one selected from the group consisting of sentences, voices, and images. Further, specific examples of the data indicating a social trend include an article exposed on the Internet or the like such as social networking service (SNS), and the results of a questionnaire survey conducted by a research firm. However, the present example embodiment is not limited to these examples.

Note that the reference data DR may be acquired in advance, and may be acquired during the process carried out by the correcting section 13. For example, the reference vector represents the reference data DR or one or more elements extracted from the reference data DR, in the form of a vector in a feature space. The one or more elements extracted from the reference data DR may be, for example, a predetermined keyword, predetermined wording, a token, or a predetermined evaluation value such as an approval rating. Like the target vector, the reference vector can be generated as a vector which represents a feature of the reference data DR in a feature space.

The correcting section 13 may make a comparison between the target vector and the reference vector by, for example, a method of computing a difference between the target vector and the reference vector in a feature space and determining whether the magnitude of the computed difference vector is within a predetermined range.

Examples of the correction-related processing of the target data DT carried out by the correcting section 13 include:
a process of making a correction to the target data DT such that the degree of difference between the target vector and the reference vector is within a predetermined range; and
a process of suggesting, to a user, making a correction to the target data DT such that the degree of difference between the target vector and the reference vector is within a predetermined range. In other words, the correcting section 13 may carry out, for example,
a process of making a correction to an article created in the mass media such that the degree of difference between a feature of the article and a feature of data indicating a social trend or the like is within a predetermined range, or
a process of suggesting making a correction to an article created in the mass media such that the degree of difference between a feature of the article and a feature of data indicating a social trend or the like is within a predetermined range.

As a specific example of the process of the correcting section 13, in a case where an article is in favor of a certain theme despite the major social trend toward the intent of being opposed to the theme, the correcting section 13 may make a correction to the article (i.e. the target data DT) such that the difference from data indicating the social trend (i.e. the reference data DR) is within a predetermined range, or may suggest making the correction.

The above suggestion of the correction can be made by the correcting section 13 presenting, to a user, the details of the correction via a presenting section such as a display panel, although the present example embodiment is not limited thereto.

### (Example Advantage of Information Processing Apparatus 1)

As described above, a configuration adopted in the information processing apparatus 1 is the configuration in which target data is acquired, a target vector is generated from the target data, and a comparison is made between the target vector and a reference vector generated from reference data and correction-related processing of the target data is performed according to the result of the comparison. The information processing apparatus 1 thus provides an example advantage of being capable of making an accurate correction to target data or suggesting making the correction.

### (Flow of Information Processing Method S1)

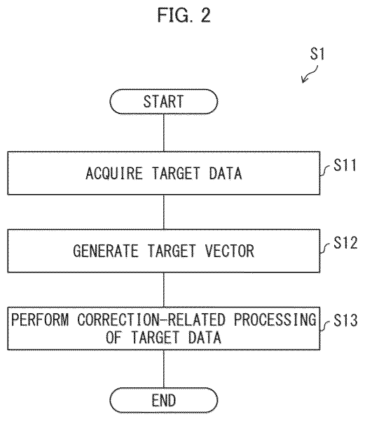

Here is a description of a flow of an information processing method S1, provided with reference to FIG. 2. FIG. 2 is a flowchart illustrating a flow of the information processing method S1. The information processing method S1 includes an acquiring process (step) S11, a generating process (step) S12, and a correcting process (step) S13, as illustrated in FIG. 2.

### (Step S11)

In step S11, the acquiring section 11 acquires target data DT. Since a specific process carried out by the acquiring section 11 is described above, the description thereof is omitted here.

### (Step S12)

In step S12, the generating section 12 generates a target vector from the target data DT. Since a specific process carried out by the generating section 12 is described above, the description thereof is omitted here.

### (Step S13)

In step S13, the correcting section 13 makes a comparison between the target vector and a reference vector generated from the reference data DR, and performs correction-related processing of the target data DT according to the result of the comparison. Since a specific process carried out by the correcting section 13 is described above, the description thereof is omitted here.

### (Example Advantage of Information Processing Method S1)

As described above, a configuration adopted in the information processing method S1 is the configuration in which target data is acquired, a target vector is generated from the target data, and a comparison is made between the target vector and a reference vector generated from reference data, and correction-related processing of the target data is performed according to the result of the comparison. The information processing method S1 thus provides an example advantage of being capable of making an accurate correction to target data or suggesting making the correction.

### Second Example Embodiment

The following description will discuss a second example embodiment, which is an example embodiment of the present invention, in detail with reference to the drawings. A component having the same function as a component described in the above example embodiment is assigned the same reference sign, and the description thereof is omitted where appropriate. Note that the applicability of each of the technical means adopted in the present example embodiment is not limited to the present example embodiment. That is, each technical means adopted in the present example embodiment can be adopted in another example embodiment included in the present disclosure to the extent that no exceptional technical impediment is caused. Further, each of the technical means illustrated in the drawings referred to for describing the present example embodiment can also be adopted in another example embodiment included in the present disclosure to the extent that no exceptional technical impediment is caused.

### (Configuration of Information Processing Apparatus 1A)

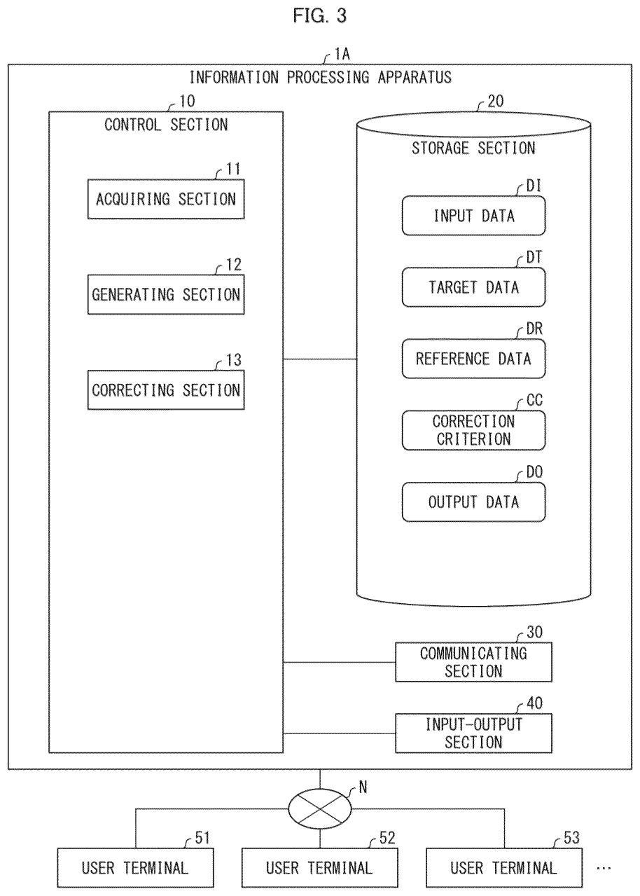

Here is a description of a configuration of an information processing apparatus 1A, provided with reference to FIG. 3. FIG. 3 is a block diagram illustrating a configuration of the information processing apparatus 1A. The information processing apparatus 1A includes a control section 10, a storage section 20, a communicating section 30, and an input-output section 40, as illustrated in FIG. 3.

### (Control Section 10)

The control section 10 includes an acquiring section 11, a generating section 12, and a correcting section 13 that are included in the information processing apparatus 1, as illustrated in FIG. 3.

### (Acquiring Section 11)

The acquiring section 11 acquires target data DT. As specific examples of the target data DT, examples of the target data DT acquired by the acquiring section 11 may include one or more sentences, in addition to those described in the first example embodiment.

### (Function of Acquiring Section 11 as Target Data Generating Section)

For example, the acquiring section 11 may have a function as a target data generating section for generating target data DT from input data DI.

The input data DI may be, for example, data composed of at least one selected from the group consisting of an image, a voice, and text. Specific examples of the input data DI include data gathered through journalism in the mass media or the like. Further, the input data DI may be put to the generation of the target data DT.

For example, in a case of functioning as the target data generating section, the acquiring section 11 may generate the target data DT which indicates the content of the input data DI, by performing processing of the image, voice, and text contained in the input data DI, and any other processing. The processing of the image is, for example, image recognition processing of the image, the processing of the voice is, for example, voice recognition processing of the voice, and the processing of the text is, for example, natural language processing of the text. Specific examples of the natural language processing include syntactic analysis and morphological analysis. Note that the target data DT which indicates the content of the input data DI may be, for example, text data such as a sentence.

### (Generating Section 12)

The generating section 12 generates a target vector from the target data DT. As an example of the target vector generation method, the generating section 12 may generate the target vector with reference to at least one of the one or more sentences contained in the target data DT, in addition to those described in the first example embodiment. Further, for example, the generating section 12 may refer to training data to optimize a machine-learned model, and generate the target vector with use of the machine-learned model optimized, the training data containing the target data DT and a ground truth label associated with the target data DT, the ground truth label being assigned to the target vector.

### (Correcting Section 13)

As described in the first example embodiment, the correcting section 13 makes a comparison between the target vector and a reference vector generated from the reference data DR, and performs correction-related processing of the target data DT according to the result of the comparison. As an example, the correcting section 13
evaluates the difference between the target vector and the reference vector in terms of a numerical value, and
in a case where the numerical value indicating the difference is within a correction criterion, does not perform the correction-related processing of the target data DT, but
in a case where the numerical value indicating the difference is not within the correction criterion, performs the correction-related processing of the target data DT.

As the difference between the target vector and the reference vector, an index obtained through processing such as computation of the inner product of the vectors and norms of the vectors, although the present example embodiment is not limited thereto.

As an example of the correction-related processing carried out by the correcting section 13, the correcting section 13 may perform, in addition to that described in the first example embodiment, correction-related processing of making a correction to the target data DT or suggesting making the correction to the target data DT, and acquiring the target data DT corrected.

### (Storage Section 20)

In the storage section 20, various kinds of data to which the control section 10 refers and various kinds of data generated by the control section 10 are stored. As an example, in the storage section 20,
input data DI
target data DT
reference data DR
correction criterion CC
output data DO
   are stored.

The input data DI may be, for example, data composed of at least one selected from the group consisting of an image, a voice, and text. Specific examples of the input data DI include data gathered through journalism in the mass media or the like. In addition, the input data DI may be put to the generation of the target data DT carried out by the acquiring section 11.

The target data DT may be, for example, at least one selected from the group consisting of an image, a voice, and text. The target data DT may be data of any field, and examples thereof include data such as an image, a voice, and text which are contained in an article and an editorial created in the mass media. Examples of the mass media include a newspaper and a broadcast. In addition, the target data DT may be put to the generation of the target vector carried out by the generating section 12.

The reference data DR may be, for example, at least one selected from the group consisting of an image, a voice, and text. The reference data DR may be data in any field, and is, for example, data which indicates the tones of past article and editorial created in the mass media, or a social trend or the like. Note that the reference data DR may be acquired in advance, and may be acquired during the process carried out by the correcting section 13.

### (Data Such as Tones of Past Article and Editorial)

For example, the reference data DR may contain a plurality of pieces of data each accumulated as the target data DT of a past time. In this case, the target data DT of a past time may be data which indicates the tones of past article and editorial created in the mass media. In this case, the correcting section 13 may, for example, make a comparison between a target vector generated from the target data DT created in the mass media and a reference vector generated from the reference data DR, and perform correction-related processing of the target data DT according to the result of the comparison. In this manner, consistency between the target data DT and the tones of the article and editorial created in the past may be sought in the mass media.

### (Data Indicating Social Trend or the Like)

The data indicating a social trend or the like can be acquired as, for example, respective pieces of data (also referred to as pieces of trend data) created by a plurality of persons, the pieces of data being at least one selected from the group consisting of sentences, voices, and images. For example, the sentences, voices, and images may be reflective of the intents of respective creators. In this case, for example, the intents of the respective creators who are members of the public may indicate the social trend or the like. Further, specific examples of the data indicating a social trend include an article exposed on the Internet or the like such as social networking service (SNS), and the results of a questionnaire survey conducted by a research firm. However, the present example embodiment is not limited to these examples. Further, for example, regarding the data indicating a social trend or the like, assuming that an area to which a creator belongs or a period of time of creation is within a predetermined range, data indicating the social trend in the area and in the period of time may be acquired. Furthermore, for example, regarding the data which indicates a social trend or the like, the improvement in reliability of the data may be sought by increasing the number of creators.

The correction criterion CC is, for example, data serving as the criterion for performing the correction-related processing of the target data DT in the correcting section 13. For example, the correction criterion CC may be a threshold regarding the difference between the target vector and the reference vector. Further, the correction criterion CC may be, for example, a numerical value which indicates an evaluation regarding a public concern about a specific field gathered from the data indicating a social trend. Furthermore, for example, the correcting section 13 may refer to the correction criterion CC, to perform the correction-related processing of the target data DT such that the degree of difference between the target vector and the reference vector is within a predetermined range.

For example, the output data DO is the target data DT corrected, which is outputted from the correcting section 13.

### (Communicating Section 30)

The communicating section 30 conducts communication with an apparatus external to the information processing apparatus 1A. As an example, the communicating section 30 conducts communication with one or more user terminals (user terminals 51, 52, 53, . . . in FIG. 3) connected to the information processing apparatus 1A via a network N. The communicating section 30 transmits, to the outside, data provided by the control section 10, and provides the control section 10 with data received from the user terminals 51, 52, 53, . . . . As a specific configuration of the network N, a wireless local area network (LAN), a wide area network (WAN), a public network, a mobile data communication network, or a combination thereof can be used, although the present example embodiment is not limited to the specific configurations.

Note that the user terminals 51, 52, 53, . . . may be provided at the time when, for example, the input data DI, the target data DT, the output data DO, etc. are exchanged between one or more users and the information processing apparatus 1A.

### (Input-Output Section 40)

The input-output section 40 has such a configuration as to include at least one of pieces of input-output equipment such as a keyboard, a mouse, a display, a printer or a touch panel. Alternatively, the input-output section 40 may be configured such that input/output equipment such as a keyboard, a mouse, a display, a printer, or a touch panel is connected thereto. In a case of this configuration, the input-output section 40 accepts input, to the information processing apparatus 1A, of various kinds of information via input equipment connected thereto. Further, the input-output section 40 outputs various kinds of information to output equipment connected thereto, under the control of the control section 10. Examples of the input-output section 40 include an interface such as a universal serial bus (USB).

### (Flow of Processes Carried Out by Information Processing Apparatus 1A)

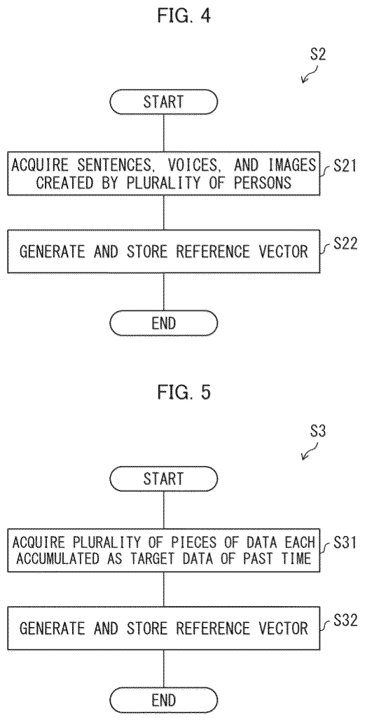

Here is a description of a flow of processes carried out by the information processing apparatus 1A, provided with reference to FIGS. 4 to 6.

(Flow of Method S2 for Generating Reference Vector from Data Indicating Social Trend)

FIG. 4 is a flowchart illustrating a flow of a method S2 for generating a reference vector from data indicating a social trend in the reference data DR. Illustrated in FIG. 4 is an example case where data indicating a social trend is each of respective pieces of data created by a plurality of persons, the pieces of data being at least one selected from the group consisting of sentences, voices, and images.

### (Step S21)

In step S21, the acquiring section 11 acquires respective pieces of data created by a plurality of persons, the pieces of data being at least one selected from the group consisting of sentences, voices, and images.

### (Step S22)

In step S22, the acquiring section 11 generates a reference vector from the data acquired in step S21, and stores the reference vector.

(Flow of Method S3 for Generating Reference Vector from Target Data of Past Time)

FIG. 5 is a flowchart illustrating a flow of a method S3 for generating a reference vector from a plurality of pieces of data each accumulated as target data DT of a past time in the reference data DR.

### (Step S31)

In step S31, the acquiring section 11 acquires a plurality of pieces of data each accumulated as the target data DT of a past time.

### (Step S32)

In step S32, the acquiring section 11 generates a reference vector from the data acquired in step S31, and stores the reference vector.

### (Flow of Information Processing Method S1A Carried Out by Information Processing Apparatus 1A)

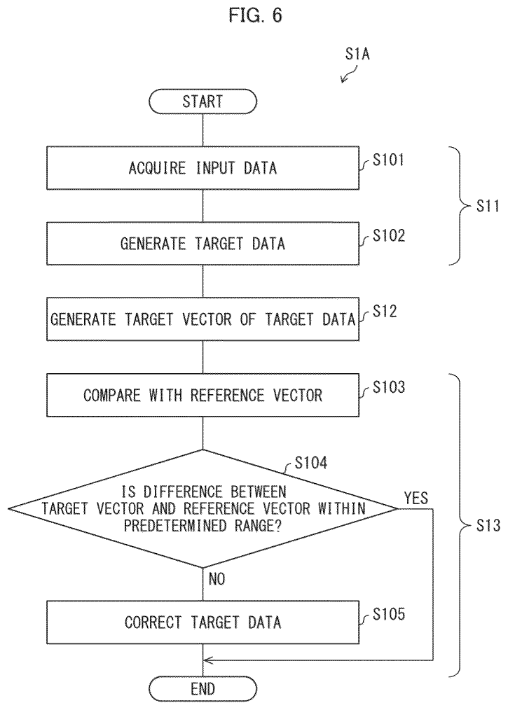

FIG. 6 is a flowchart illustrating a flow of an information processing method S1A carried out by the information processing apparatus 1A. Note that step S11 of the information processing method S1 corresponds to steps S101 and S102 of the information processing method S1A, and step S13 of the information processing method S1 corresponds to steps S103 to S105 of the information processing method S1A.

### (Step S101)

In step S101, the acquiring section 11 acquires input data DI.

### (Step S102)

In step S102, the acquiring section 11 generates target data DT. Since specific processes carried out by the acquiring section 11 in step S101 and step S102 are explained as the functions of the target data generating section of the acquiring section 11, the descriptions thereof are omitted here.

### (Step S12)

In step S12, the generating section 12 generates a target vector from the target data DT. Since a specific process carried out by the generating section 12 is described above, the description thereof is omitted here.

### (Step S103)

In step S103, the correcting section 13 makes a comparison between the target vector and the reference vector. Since the comparison between the target vector and the reference vector carried out by the correcting section 13 is described above, the description thereof is omitted here.

### (Step S104)

In step S104, the correcting section 13 judges whether the degree of difference between the target vector and the reference vector is within a predetermined range. For example, the correcting section 13 may judge whether the difference between the target vector and the reference vector is within the range of the correction criterion CC. In a case where the difference is within the predetermined range (step S104: YES), the process ends. In a case where the difference is not within the predetermined range (step S104: NO), the process proceeds to step S105.

### (Step S105)

In step S105, the correcting section 13 corrects the target data DT. For example, the correcting section 13 may correct the target data DT such that the difference between the target vector and the reference vector is within the range of the correction criterion CC.

### (Variation of Correcting Section 13)

For example, in a case where the correctness of the content of the target data DT is required, the correcting section 13 may optimize the target vector by correcting the target vector with reference to data included in the reference data DR and belonging to a first category and correcting again the target vector with reference to data included in the reference data DR and belonging to a second category. Examples of the case where the correctness of the content of the target data DT is required include a case where the target data DT is related to medical treatment or healthcare. For example, the data belonging to the first category may be data indicating a social trend. Further, for example, the data belonging to the second category only needs to be guaranteed to have more correct content than the data belonging to the first category. Specific examples of the data belonging to the second category include a document having undergone peer review, such as an academic paper.

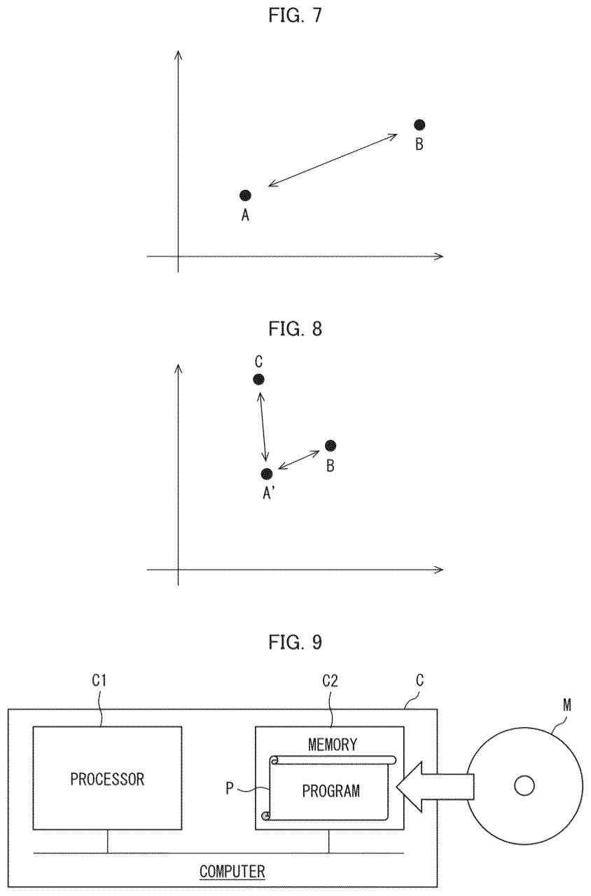

FIG. 7 is a representation illustrating, by way of example, a target vector A and a reference vector B which belongs to the first category. In FIG. 7, for example, the target vector A may be corrected according to the result of making a comparison between the target vector A and the reference vector B, which belongs to the first category.

FIG. 8 is a representation illustrating, by way of example, a target vector A′, the reference vector B belonging to the first category, and a reference vector C belonging to the second category. For example, the target vector A′ may be the target vector A in FIG. 7 that has been corrected. In FIG. 8, for example, the target vector may be optimized by correcting again the target vector A′ according to the result of making a comparison between the target vector A′ and the reference vector C belonging to the second category.

### (Example Advantage of Information Processing Apparatus 1A)

As describes above, a configuration adopted in the information processing apparatus 1A is the configuration in which the reference data contains at least one selected from the group consisting of: respective pieces of data created by a plurality of persons, the pieces of data being at least one selected from the group consisting of sentences, voices, and images; and a plurality of pieces of data each accumulated as the target data of a past time. The information processing apparatus 1A therefore provides, in addition to the example advantage produced by the information processing apparatus 1, an example advantage of being capable of making a correction to target data or suggesting making the correction in accordance with data created by a third party or the target data of a past time.

Another configuration adopted in the information processing apparatus 1A is the configuration in which a correcting means performs correction-related processing of making a correction to target data or suggesting making the correction to the target data, and acquiring the target data corrected. The information processing apparatus 1A therefore provides, in addition to the example advantage produced by the information processing apparatus 1, an example advantage of being capable of making a correction to target data or suggesting making the correction, and acquiring the target data corrected.

Another configuration adopted in the information processing apparatus 1A is the configuration in which target data acquired by an acquiring means contains one or more sentences, and the generating means generates a target vector with reference to at least one of the one or more sentences. The information processing apparatus 1A therefore provides, in addition to the example advantage produced by the information processing apparatus 1, an example advantage of being capable of generating a target vector from the target data which contains sentences.

Another configuration adopted in the information processing apparatus 1A is the configuration in which a target data generating means is further included for generating target data from input data. The information processing apparatus 1A therefore provides, in addition to the example advantage produced by the information processing apparatus 1, an example advantage of being capable of generating target data from input data.

Still another configuration adopted in the information processing apparatus 1A is the configuration in which a machine-learned model as a generating means is optimized with reference to training data which contains target vector and a ground truth label associated with the target data, the ground truth label being assigned to a target vector. The information processing apparatus 1A therefore provides, in addition to the example advantage produced by the information processing apparatus 1, an example advantage of being capable of optimizing a machine-learned model which is the generating means for generating a target vector.

Yet still another configuration adopted in the information processing apparatus 1A is the configuration in which the correcting means optimizes the target vector by correcting a target vector with reference to data belonging to the first category contained in the reference data, and by correcting again the target vector with reference to data belonging to the second category contained in the reference data. The information processing apparatus 1A therefore provides, in addition to the example advantage produced by the information processing apparatus 1, an example advantage of being capable of optimizing a target vector by correcting the target vector again.

### Software Implementation Example

Some or all of the functions of each of the information processing apparatuses 1 and 1A (hereinafter, also referred to as “each apparatus above” may be implemented by hardware such as an integrated circuit (IC chip), or may be implemented by software.

In the latter case, each apparatus above is provided by, for example, a computer that executes instructions of a program that is software implementing the foregoing functions. An example (hereinafter, computer C) of such a computer is illustrated in FIG. 9. FIG. 9 is a block diagram illustrating a hardware configuration of a computer C which functions as each apparatus above.

The computer C includes at least one processor C1 and at least one memory C2. The memory C2 has recorded thereon a program P for causing the computer C to operate as each apparatus above. The at least one processor C1 of the computer C retrieves and executes the program P from the memory C2, so that the functions of each apparatus above are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. Examples of the memory C2 can include a flash memory, a hard disk drive (HDD), a solid state drive (SSD), and a combination thereof.

The computer C may further include a random access memory (RAM) into which the program P is loaded at the time of execution and in which various kinds of data are temporarily stored. The computer C may further include a communication interface via which data is transmitted to and received from another apparatus. The computer C may further include an input-output interface via which input/output equipment such as a keyboard, a mouse, a display or a printer is connected.

The program P can be recorded on a non-transitory tangible recording medium M capable of being read by the computer C. Examples of such a recording medium M can include a tape, a disk, a card, a semiconductor memory, and a programmable logic circuit. The computer C can obtain the program P via such a recording medium M. Alternatively, the program P can be transmitted via a transmission medium. Examples of such a transmission medium can include a communication network and a broadcast wave. The computer C can obtain the program P also via such a transmission medium.

### [Additional Remark 1]

The whole or part of the example embodiments disclosed above can be described as, but not limited to, the following supplementary notes.

### (Supplementary Note 1)

An information processing apparatus including:
an acquiring means for acquiring target data;
a generating means for generating a target vector from the target data; and
a correcting means for making a comparison between the target vector and a reference vector generated from reference data, and performing correction-related processing of the target data according to a result of the comparison.

### (Supplementary Note 2)

The information processing apparatus described in supplementary note 1, in which
the reference data contains at least one selected from the group consisting of:
   respective pieces of trend data created by a plurality of persons, the pieces of trend data being at least one selected from the group consisting of sentences, voices, and images; and
   a plurality of pieces of data each accumulated as the target data of a past time.

### (Supplementary Note 3)

The information processing apparatus described in supplementary note 2, in which the correcting means is configured to perform the correction-related processing of making a correction to the target data or suggesting making the correction to the target data, and acquiring the target data corrected.

### (Supplementary Note 4)

The information means apparatus s described in supplementary note 3, in which
the target data acquired by the acquiring means contains one or more sentences, and
the generating means is configured to generate the target vector with reference to at least one of the one or more sentences.

### (Supplementary Note 5)

The information processing apparatus described in any one of supplementary notes 1 to 4, further including
a target data generating means for generating the target data from input data.

### (Supplementary Note 6)

The information processing apparatus described in supplementary note 5, in which
the generating means is configured to
   optimize a machine-learned model with reference to training data which contains the target data and a ground truth label associated with the target data, the ground truth label being assigned to the target vector, and
   generate the target vector with use of the machine-learned model optimized.

### (Supplementary Note 7)

The information processing apparatus described in any one of supplementary notes 1 to 4, in which
the correcting means is configured to optimize the target vector by
   correcting the target vector with reference to data which is contained in the reference data and which belongs to a first category, and
   correcting again the target vector with reference to data which is contained in the reference data and which belongs to a second category.

### (Supplementary Note 8)

An information processing method including:
acquiring target data;
generating a target vector from the target data; and
making a comparison between the target vector and a reference vector generated from reference data, and performing correction-related processing of the target data according to a result of the comparison.

### (Supplementary Note 9)

The information processing method described in supplementary note 8, in which
the reference data contains at least one selected from the group consisting of:
   respective pieces of trend data created by a plurality of persons, the pieces of trend data being at least one selected from the group consisting of sentences, voices, and images; and
   a plurality of pieces of data each accumulated as the target data of a past time.

### (Supplementary Note 10)

The information processing method described in supplementary note 9, in which
in the correcting, the correction-related processing of making a correction to the target data or suggesting making the correction to the target data, and acquiring the target data corrected is performed.

### (Supplementary Note 11)

The information processing method described in supplementary note 10, in which
the target data acquired in the acquiring process contains one or more sentences, and
in the generating, the target vector with reference to at least one of the one or more sentences is generated.

### (Supplementary Note 12)

The information processing method described in any one of supplementary notes 8 to 11, further including generating the target data from input data.

### (Supplementary Note 13)

The information processing method described in supplementary note 12, in which
a machine-learned model which carries out the generating is optimized with reference to training data which contains the target data and a ground truth label associated with the target data, the ground truth label being assigned to the target vector.

### (Supplementary Note 14)

The information processing method described in any one of supplementary notes 8 to 11, in which
in the correcting, the target vector is optimized by
   correcting the target vector with reference to data which is contained in the reference data and which belongs to a first category, and
   correcting again the target vector with reference to data which is contained in the reference data and which belongs to a second category.

### (Supplementary Note 15)

A program for causing a computer to operate as the information processing apparatus described in any one of supplementary notes 1 to 7, the program causing the computer to function as the acquiring means, the generating means, and the correcting means.

### [Additional Remark 2]

The whole or part of the example embodiments disclosed above can be described as, but not limited to, the following supplementary notes.

### (Supplementary Note 1)

An information processing apparatus including at least one processor, the at least one processor carrying out:
an acquiring process of acquiring target data;
a generating process of generating a target vector from the target data; and
a correcting process of making a comparison between the target vector and a reference vector generated from reference data, and performing correction-related processing of the target data according to a result of the comparison.

The information processing apparatus may further include a memory. The memory may have recorded thereon a program for causing the at least one processor to carry out the acquiring process, the generating process, and the correcting process.

### (Supplementary Note 2)

The information processing apparatus described in supplementary note 1, in which
the reference data contains at least one selected from the group consisting of:
   respective pieces of trend data created by a plurality of persons, the pieces of trend data being at least one selected from the group consisting of sentences, voices, and images; and
   a plurality of pieces of data each accumulated as the target data of a past time.

### (Supplementary Note 3)

The information processing apparatus described in supplementary note 2, in which
in the correcting process, the at least one processor performs the correction-related processing of making a correction to the target data or suggesting making the correction to the target data, and acquiring the target data corrected.

### (Supplementary Note 4)

The information processing apparatus described in supplementary note 3, in which
in the acquiring process, the target data acquired by the at least one processor contains one or more sentences, and
in the generating process, the at least one processor generates the target vector with reference to at least one of the one or more sentences.

### (Supplementary Note 5)

The information processing apparatus described in any one of supplementary notes 1 to 4, in which
the at least one processor
further carried out a target data generating process of generating the target data from input data.

### (Supplementary Note 6)

The information processing apparatus described in supplementary note 5, in which
a machine-learned model is optimized which is the generating means with reference to training data which contains the target data and a ground truth label associated with the target data, the ground truth label being assigned to the target vector.

### (Supplementary Note 7)

The information processing apparatus described in any one of supplementary notes 1 to 4, in which
in the correcting process, the at least one processor optimizes the target vector by
   correcting the target vector with reference to data which is contained in the reference data and which belongs to a first category, and
   correcting again the target vector with reference to data which is contained in the reference data and which belongs to a second category.

### REFERENCE SIGNS LIST

1, 1A: Information processing apparatus
10: Control section
11: Acquiring section
12: Generating section
13: Correcting section
20: Storage section
30: Communicating section
40: Input-output section
51, 52, 53, . . . : User terminal
C1: Processor
C2: Memory

1. An information processing apparatus comprising at least one processor, the at least one processor carrying out:
an acquiring process of acquiring target data;
a generating process of generating a target vector from the target data; and
a correcting process of making a comparison between the target vector and a reference vector generated from reference data, and performing correction-related processing of the target data according to a result of the comparison.

2. The information processing apparatus according to claim 1, wherein
the reference data contains at least one selected from the group consisting of:
respective pieces of trend data created by a plurality of persons, the pieces of trend data being at least one selected from the group consisting of sentences, voices, and images; and
a plurality of pieces of data each accumulated as the target data of a past time.

3. The information processing apparatus according to claim 2, wherein
in the correcting process, a correction is made to the target data or making the correction to the target data is suggested, and the target data corrected is acquired.

4. The information processing apparatus according to claim 3, wherein
the target data acquired in the acquiring process contains one or more sentences, and
in the generating process, the target vector is generated with reference to at least one of the one or more sentences.

5. The information processing apparatus according to claim 1, wherein
the at least one processor further carries out
a target data generating process of generating the target data from input data.

6. The information processing apparatus according to claim 5, wherein
in the generating process,
a machine-learned model is optimized with reference to training data which contains the target data and a ground truth label associated with the target data, the ground truth label being assigned to the target vector, and
the target vector is generated with use of the machine-learned model optimized.

7. The information processing apparatus according to claim 1, wherein
in the correcting process, the target vector is optimized by
correcting the target vector with reference to data which is contained in the reference data and which belongs to a first category, and
correcting again the target vector with reference to data which is contained in the reference data and which belongs to a second category.

8. An information processing method comprising:
acquiring target data;
generating a target vector from the target data; and
making a comparison between the target vector and a reference vector generated from reference data, and performing correction-related processing of the target data according to a result of the comparison.

9. A non-transitory recording medium having recorded thereon a program for causing a computer to carry out:
an acquiring process of acquiring target data;
a generating process of generating a target vector from the target data; and
a correcting process of making a comparison between the target vector and a reference vector generated from reference data, and performing correction-related processing of the target data according to a result of the comparison.
